(19) United States
(12) Patent Application Publication
(10) Pub. No.: US 2006/0045523 A1
(43) Pub. Date: Mar. 2, 2006

(54) Online system for designing a fiber optic network and associated methods

(76) Inventor: David R. Kozischek, Hickory, NC (US)

Correspondence Address: CORNING CABLE SYSTEMS LLC, P O BOX 489, HICKORY, NC, 28603, US

(21) Appl. No.: 10/930,890

(22) Filed: Aug. 31, 2004

(51) Int. Cl. H04B 10/20

(52) U.S. Cl. 398/58

(57) ABSTRACT

A computer implemented online system for fiber optic network design includes a user interface module to prompt and receive user input data over a global computer network, such as the Internet, relating to the fiber optic network design, and a fiber optic parameter database storing a plurality of fiber optic parameters. The system may further include a calculator/network analyzer module to calculate fiber optic network design data based upon the user input data and the stored fiber optic parameters. In addition, the system may include a user report module to send a fiber optic network design report to the user over the Internet based upon the calculated fiber optic network design data. The fiber optic network design data may include optical fiber type data, and/or optical fiber cable count data.

### FIELD OF THE INVENTION

The present invention relates to the field of fiber optic network design, and, more particularly, to an online system and method for designing a fiber optic network that is implemented by a computer over a global computer network.

### BACKGROUND OF THE INVENTION

Private communications networks are often used to connect many users in a given building or to connect users in multiple buildings within a campus setting. Fiber optic cables and components offer a number of advantages for such private communications networks. Corning Cable Systems LLC, the assignee of the present invention, published a Design Guide (the current version of which is Release 5) to address the increasing usefulness of optical fiber for private networks, the disclosure of which is incorporated herein by reference.

The Design Guide notes that the successful deployment of information technology is critical to the success of most businesses and organizations, and that the need to access and share information is fueling a new level of demand for the Internet, Local Area Network (LAN) and intranet based client/server applications. Indeed, new applications standards continue to be developed to support these requirements, like Gigabit Ethernet and Multi-Gigabit Fibre Channel. Ethernet and Fibre Channel applications at 10 Gb/s and beyond are now available.

Fiber optic cable is considered as more robust and flexible than competing copper cable. The dielectric construction of optical cable does not restrict its placement in the vicinity of noise sources, such as fluorescent lights, electric motors, and power cable. Optical cables may also be relatively easy to terminate with no-epoxy and no-polish connectors. As such, many private networks can now be based upon full fiber connectivity to the user's desktop.

A typical fiber optic private network may include a campus backbone where one of the buildings serves as the main cross-connect (MC), while other buildings will contain intermediate cross-connects (ICs). Fiber optic cables may also be routed from the ICs to one or more horizontal cross-connects (HCs). Work area cables may extend from the HCs to the individual desktops in an all fiber optic system. A number of logical cabling schemes can be implemented with a physical star cabling arrangement as disclosed in the Design Guide and as found in the TIA/EIA-568B Standard.

The TIA/EIA-568B Standard includes recommendations as they relate to optical fiber and topologies as follows. The rules for backbone cabling include a 2000 meter limit for multimode (MM) fiber having a 50 μm core and 125 μm cladding, or a 62.5 μm core and 125 μm cladding. This distance limit is 3000 meters for single-mode (SM) fiber. The distance is measured from the MC to the HC, and with a maximum of one IC therebetween.

As noted in the Design Guide, the physical design of the system desirably reduces the number of splices. The small incremental cost of additional cable sheaths will usually offset the cost of splicing different fiber-count cables together. Where a constrained duct or conduit space precludes the use of multiple sheaths, a consolidation splice may be used. When pulling longer cables through duct or conduit, a desired fill ratio should be observed. For a single cable, less than a 65% fill ratio is recommended in the Design Guide.

A number of different fiber types, transmitters and receivers have been recognized by TIA/EIA-568B and IEEE 802.3. Accordingly, the Design Guide sets forth tables of different applications, along with data rates, maximum distances, and operating wavelengths.

In the past, the various fiber types, cable counts, etc. have been painstakingly prepared by a design engineer based upon the specific customer's particular private network requirements. Although some spreadsheets could be custom prepared and used, considerable engineering effort was required. In other words, fiber optic private network designs often require many man-days of engineering labor for even relatively simple campus networks. Updating a given model or considering alternate topologies requires considerable additional engineering time.

### SUMMARY OF THE INVENTION

In view of the foregoing background, it is therefore an object of the present invention to provide a system and method for fiber optic network design that permits users to efficiently and promptly obtain network designs.

This and other objects, features and advantages in accordance with the present invention are provided by an online system implemented by a computer over a global computer network, such as the Internet, for fiber optic network design comprising a user interface module to prompt and receive user input data over the Internet relating to the fiber optic network design, and a fiber optic parameter database storing a plurality of fiber optic parameters. The system may further include a calculator/network analyzer module connected to the user interface module and the fiber optic parameter database to calculate fiber optic network design data based upon the user input data and the stored fiber optic parameters. In addition, the system may include a user report module connected to the calculator/network analyzer module to send at least one fiber optic network design report to the user over the Internet based upon the calculated fiber optic network design data. Accordingly, one or more users may quickly and efficiently obtain fiber optic network designs.

The fiber optic network design data may comprise optical fiber type data, such as, for example, identification of at least one of a multimode (MM) optical fiber having a first core diameter, a multimode (MM) optical fiber having a second core diameter larger than the first core diameter, and a single mode (SM) optical fiber. The fiber optic network design data may further comprise optical fiber cable count data. In addition, the fiber optic network design data may comprise different optical fiber type data and different optical fiber cable count data for different fiber optic network topologies. For example, the different fiber optic network topologies may include a point-to-point topology, a point-to-multipoint topology, and a mesh topology.

The stored fiber optic parameters may include different fiber optic parameters for different user applications, such as for 10 GigE or 1 GigE, for example. The stored fiber optic parameters may comprise fiber optic parameters based upon at least one industry standard, such as the TIA/EIA-568 standard or the IEEE 802.3 standard. Alternately or additionally, the stored fiber optic parameters may comprise fiber optic parameters based upon at least one optical fiber cable manufacturer's guidelines.

The user input data may include distances between predetermined locations. For example, the predetermined locations comprise a plurality of buildings in a campus setting. Also, the predetermined locations may further comprise different floors in at least one of the buildings.

The user input data may comprise input data based upon fibers needed for different applications. Such different applications may include security video, card readers, video conferencing, security alarms, and/or broadband CATV, for example.

The fiber optic network design data may comprise cost data. Accordingly, the at least one report may comprise an optical fiber mix breakeven graph. The at least one report may also comprise an optical fiber cable and electronics cost graph.

In accordance with another advantageous feature of the invention, the online system may include a user model database connected to the calculator/network analyzer module for storing user fiber optic network design data for a given set of user input data. This database may not only be used in repeat visits by a user, but a data mining module may be connected to the user model database to permit data mining therefrom.

Another aspect of the invention is directed to an online method for fiber optic network design that is implemented by a computer over a global computer network, such as the Internet. The method may include prompting and receiving user input data over the Internet relating to the fiber optic network design, and storing a plurality of fiber optic parameters. The method may further include using a calculator/network analyzer module to calculate fiber optic network design data based upon the user input data and the stored fiber optic parameters. Of course, the method may also include sending at least one fiber optic network design report to the user over the Internet based upon the calculated fiber optic network design data.

### BRIEF DESCRIPTION OF THE DRAWINGS

FIG. 1 is a schematic block diagram of an exemplary computer implemented online fiber optic network design system in accordance with the invention.

FIG. 2 is a building/campus layout for the example computer online fiber optic network design system shown in FIG. 1.

FIG. 3 is a representative screen for the example illustrating user input prompts and user input data.

FIG. 4 is another representative screen for the example illustrating additional user input prompts and user input data.

FIG. 5 is a fiber optic parameter table as used in the computer implemented online fiber optic network design system shown in FIG. 1.

FIG. 6 is another fiber optic parameter table as used in the computer implemented online fiber optic network design system shown in FIG. 1.

FIG. 7 is yet another fiber optic parameter table as used in the computer implemented online fiber optic network design system shown in FIG. 1.

FIG. 8 is still another fiber optic parameter table as used in the computer implemented online fiber optic network design system shown in FIG. 1.

FIG. 9 is a representative screen for the example illustrating a fiber backbone topology comparison report.

FIG. 10 is another representative input screen for the example to produce cost reports.

FIG. 11 is a fiber mix breakeven analysis graphical report for the example.

FIG. 12 is a cost analysis report for the example for a 1 GigE portion.

FIG. 13 is a cost analysis report for the example for a 10 GigE portion.

FIG. 14 is a cost analysis report for the example including the 1 GigE trunk and 10 GigE portions.

FIG. 15 is a representative screen of a traffic calculator report for the example.

FIG. 16 is a representative screen of a link loss calculation report for the example.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

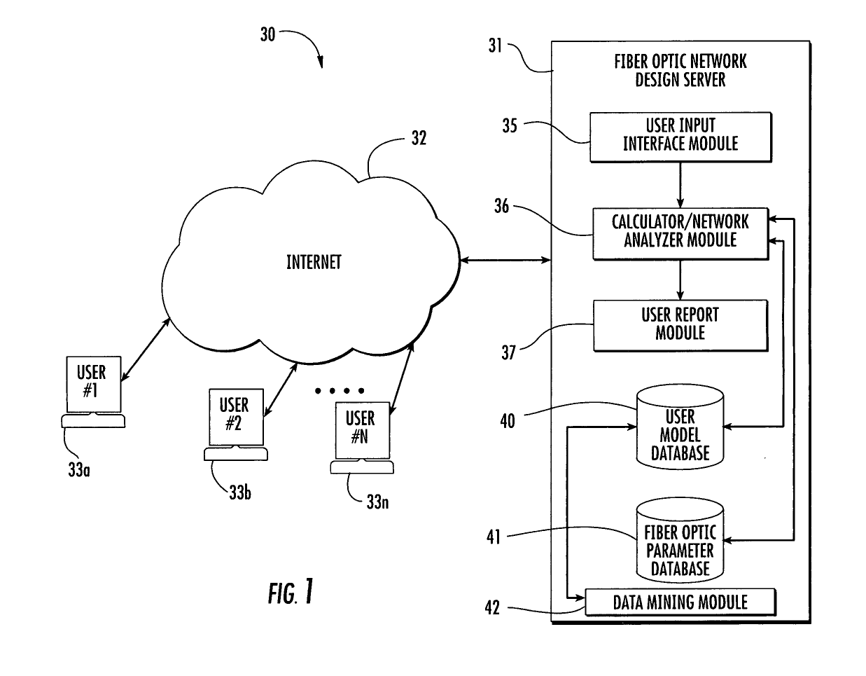

Referring now initially to FIG. 1, an exemplary computer implemented online system 30 for fiber optic network design is now described. The system 30 illustratively includes a fiber optic network design server 31 operatively connected to a global computer network, such as the Internet 32. The server 31 may be operated by a fiber optic cable manufacturer, such as the assignee of the present invention, for example. Of course, other entities may also operate the server 31 in other embodiments as will be appreciated by those skilled in the art.

A plurality of user computers 33a-33n are operatively connected to the Internet 32 and may be simultaneously or sequentially logged onto the fiber optic network design server 31. For example, access of users to the server 31 may be controlled by passwords. The users may be prospective customers of the server operator, such as those planning or considering a fiber optic private network.

As will readily be appreciated by those skilled in the art, the fiber optic network design server 31 may include a processor and associated memory running software programs to define the various modules next described. As shown in the illustrated embodiment, the server 31 may include a user interface module 35 to prompt and receive user input data over the Internet 32 relating to the fiber optic network design. The server 31 also includes a fiber optic parameter database 41 storing a plurality of fiber optic parameters.

The server 31 further includes a calculator/network analyzer module 36 connected to the user input interface module 35 and the fiber optic parameter database 41 to calculate fiber optic network design data based upon the user input data and the stored fiber optic parameters. The server 31 also illustratively includes a user report module 37 connected to the calculator/network analyzer module 36 to send at least one fiber optic network design report to the user over the Internet 32 based upon the calculated fiber optic network design data. As a result, one or more connected users may quickly and efficiently obtain fiber optic network designs via their respective computers 33a-33n.

Having now described at the general level the various modules of the server 31 of the system 30, further operational features are now described before moving to an example of a fiber optic network design performed using the system 30. The fiber optic network design data may comprise optical fiber type data, such as, for example, identification of at least one of a multimode (MM) optical fiber having a first core diameter, a multimode (MM) optical fiber having a second core diameter larger than the first core diameter, and a single mode (SM) optical fiber. Various fiber types are extensively described in the product literature of cable manufacturers, such as the assignee of the present invention. Fiber optic types are also described in various industry standards, such as the TIA/EIA-568B standard, and the IEEE 802.3 standard, for example. Of course, these standards are but representative and those of skill in the art will appreciate other standards as well. The optical fiber parameters are typically entered and updated in the fiber optic parameter database 41 by the server operator or administrator.

The fiber optic network design data may further comprise optical fiber cable count data. In other words, the calculator/network analyzer module 36 can determine fiber types and counts to be included by the user report module 37 in one or more reports sent to the user. For example, the fiber optic network design data may comprise different optical fiber type data and different optical fiber cable count data for different fiber optic network topologies. The different fiber optic network topologies may include a point-to-point topology, a point-to-multipoint topology, and a mesh topology as will be appreciated by those skilled in the art, although other topologies are also contemplated by the invention.

The stored fiber optic parameters in the database 41 and used by the calculator/network analyzer module 36 may include different fiber optic parameters for different user applications, such as for 10 GigE or 1 GigE, for example.

As noted above, the stored fiber optic parameters may generally comprise fiber optic parameters based upon at least one industry standard, such as the TIA/EIA-568B standard or the IEEE 802.3 standard. Alternately or additionally, the stored fiber optic parameters may comprise fiber optic parameters based upon at least one optical fiber cable manufacturer's guidelines.

The user input data prompted and received by the user input interface module 35 may include distances between predetermined locations. The predetermined locations may typically include a plurality of buildings in a campus setting, although the system 30 could be used for even a single building having multiple floors. Of course, the predetermined locations may further comprise different floors in at least one of the buildings of the campus arrangement of buildings.

The user input data may comprise input data based upon fibers needed for different applications. Such different applications may include security video, card readers, video conferencing, security alarms, and/or broadband CATV, for example. Other applications of dedicated fibers are also possible as will be appreciated by those skilled in the art.

In accordance with significant advantages of the system 30, the fiber optic design network data may comprise cost data. Accordingly, the fiber optic design network data may be processed by the calculator/network analyzer module 36 to generate cost-based graphs and reports to be sent to the user by the user report module 37. As will be discussed in greater detail in the following example, the cost-based reports may comprise an optical fiber mix breakeven graph, or one or more optical fiber cable and electronics cost graphs. The calculated cost data may be based at least in part, on user input unit costs, such as cost per foot of cable.

Another advantageous feature of the system relates to storage of user models. Considered in other terms, the server 31 of the online system 30 may include a user model database 40 connected to the calculator/network analyzer module 36 for storing user fiber optic network design data for a given set of user input data. This user model database 40 may not only be used in repeat visits by a user, but a data mining module 42 may be connected to the user model database to permit data mining therefrom. For example, the data mining module 42 may be used to generate specific or targeted sales leads for follow-up calls or emails, although other data mining uses are also possible as will be appreciated by those skilled in the art.

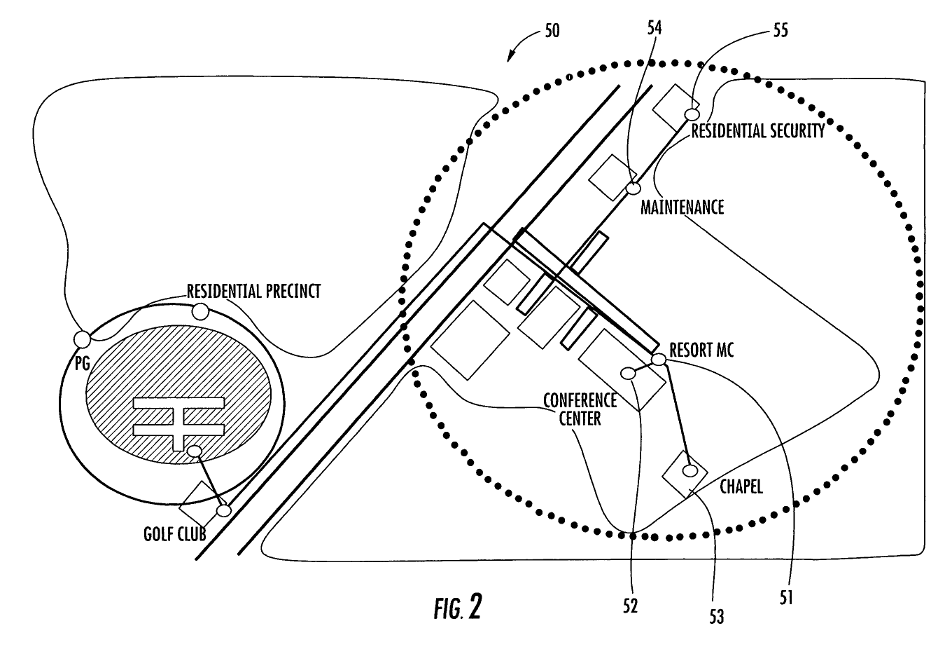

Turning now additionally to FIG. 2, a campus layout 50 of buildings 51-55 desired to be interconnected by an example fiber optic private network is described. The main cross-connect (MC) is provided at the resort 51. Various fiber optic cables, as will be described in greater detail below, interconnect the conference center 52, the chapel 53, the maintenance building 54, and the residential security building 55 to the MC at the resort 51.

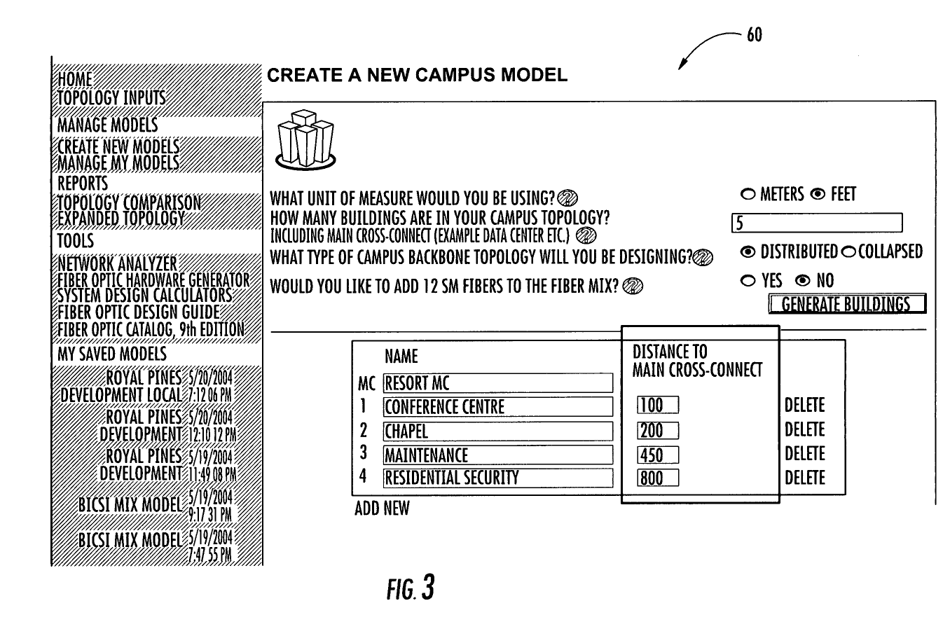

The building names and distances to the MC may be input by the user via the representative input screen 60 as shown in FIG. 3. The user has also illustratively selected a distributed fiber optic backbone, as contrasted to a collapsed backbone, on the input screen of FIG. 3.

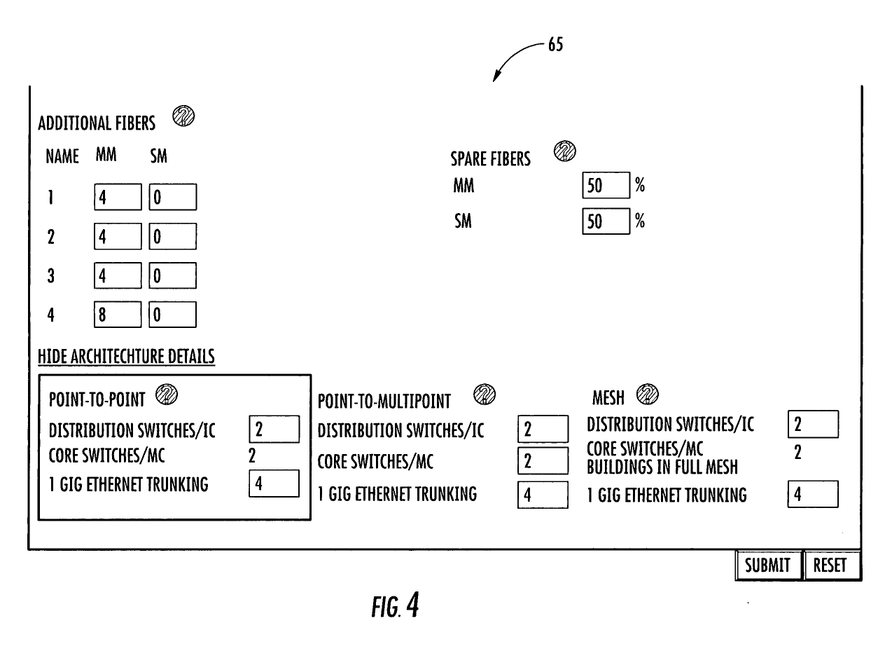

Another user input screen 65 is shown in FIG. 4 and permits a user to input additional fibers that may be needed for other applications as described above. In addition, a spare capacity of the different fiber types may also be entered. Of course, those skilled in the art will appreciate other user input screens that are possible in the system 30.

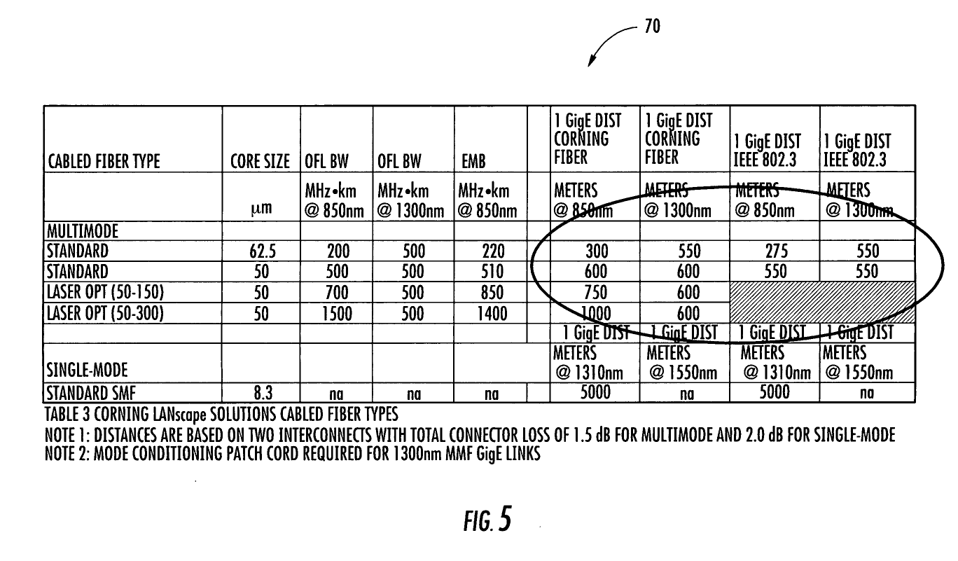

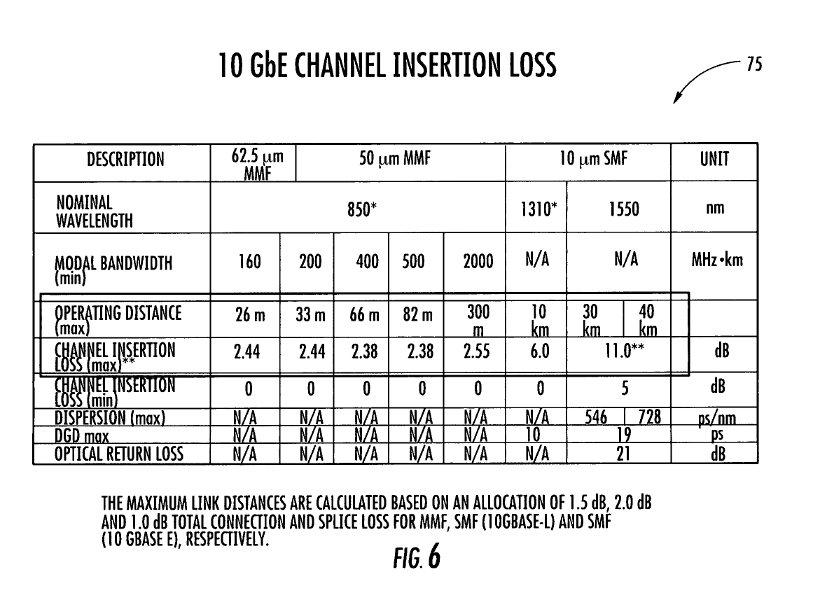

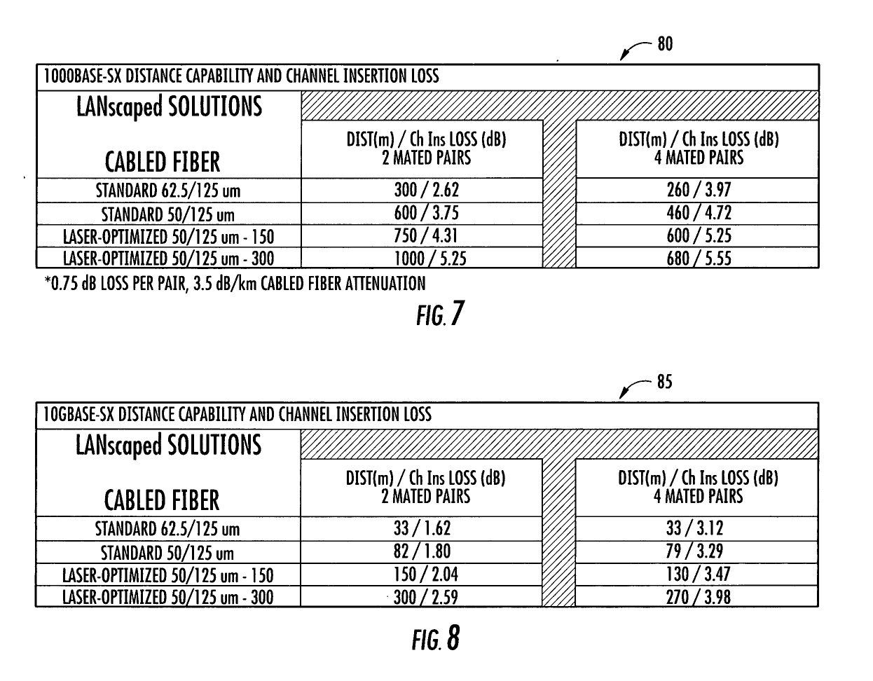

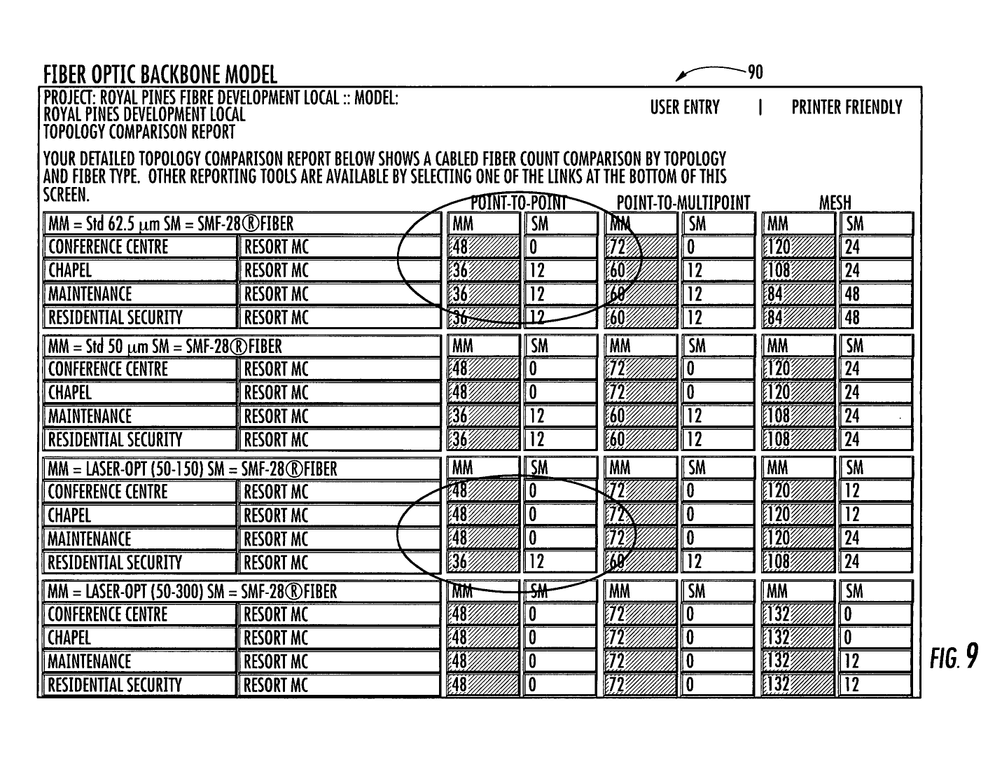

As shown in FIG. 5, various fiber optic parameters 70 for a 1 GigE application are shown in tabular form as may be stored in the fiber optic parameter database 41. Along these lines, exemplary 10 GigE channel insertion loss parameters 75 shown in tabular form in FIG. 6 may also be stored in the database 41 and used by the calculator/network analyzer module 36. FIGS. 7 and 8 respectively show distance capability and channel insertion loss data for 1 GigE and 10 GigE applications 80, 85, respectively. The calculator/network analyzer module 36 may implement basic design algorithms as previously used by design engineers, along with the fiber optic parameters described herein. These basic design algorithms will be readily appreciated by those skilled in the art, are available in fiber optic design courses as offered by the assignee of the present invention, and require no further discussion herein.

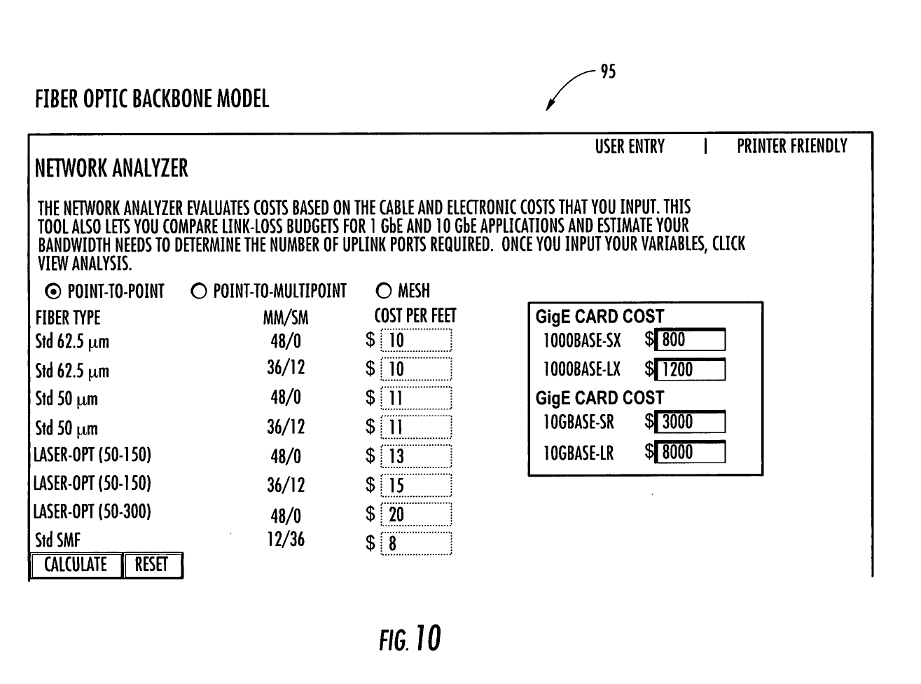

Turning now to the screen of FIG. 9, the fiber optic network design data produced by the calculator/network analyzer module 36 has been generated as a tabular topology comparison report 90. This report 90 gives different models or design scenarios for point-to-point, point-to-multipoint, and mesh topologies. In addition, the fiber counts are also given for different optical fiber mixes for the exemplary campus layout of buildings.

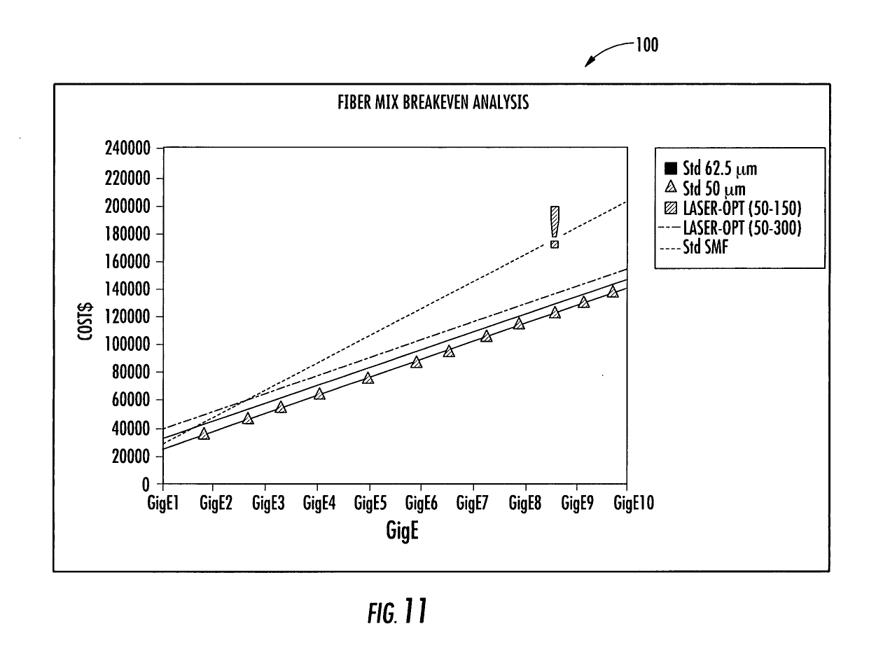

As understood with reference to the cost user input screen 95 of FIG. 10, the system 30 may also provide various cost-based reports. In the example input screen 95, cost data may be input for different cables, as well as for various electronic cards. This information may be used by the calculator/network analyzer module 36 to develop cost-based reports as explained below.

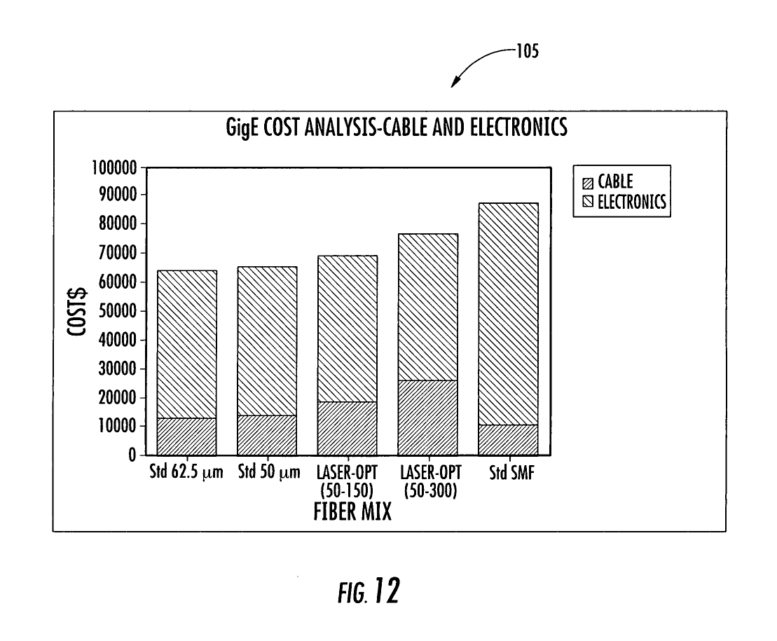

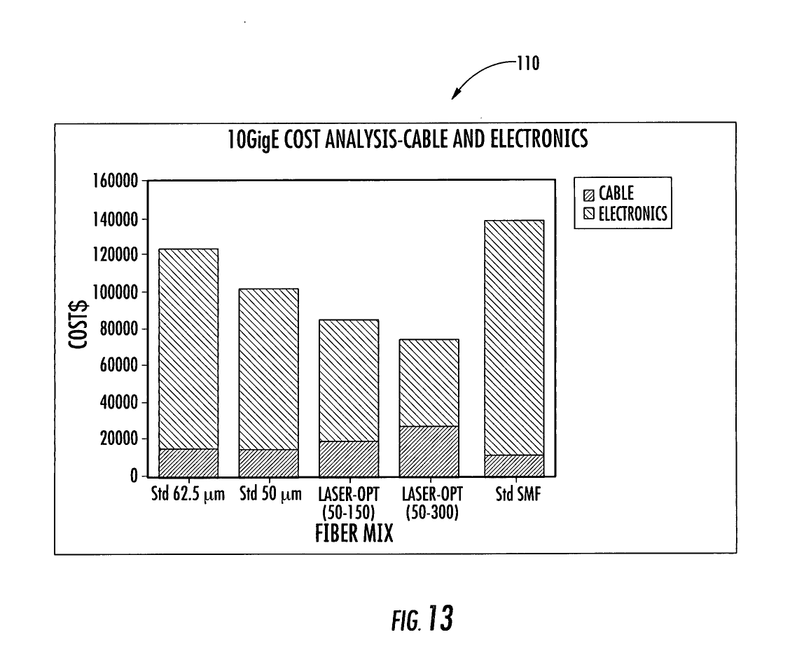

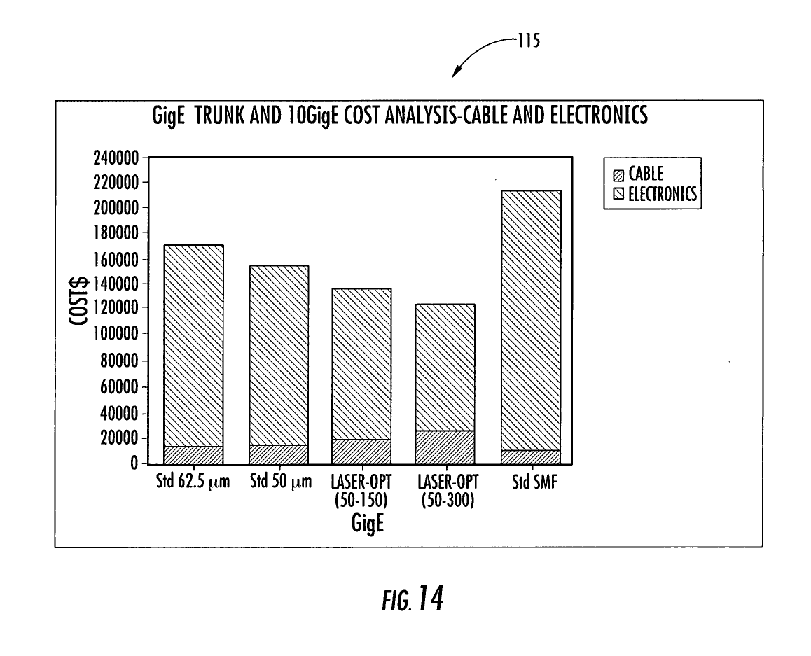

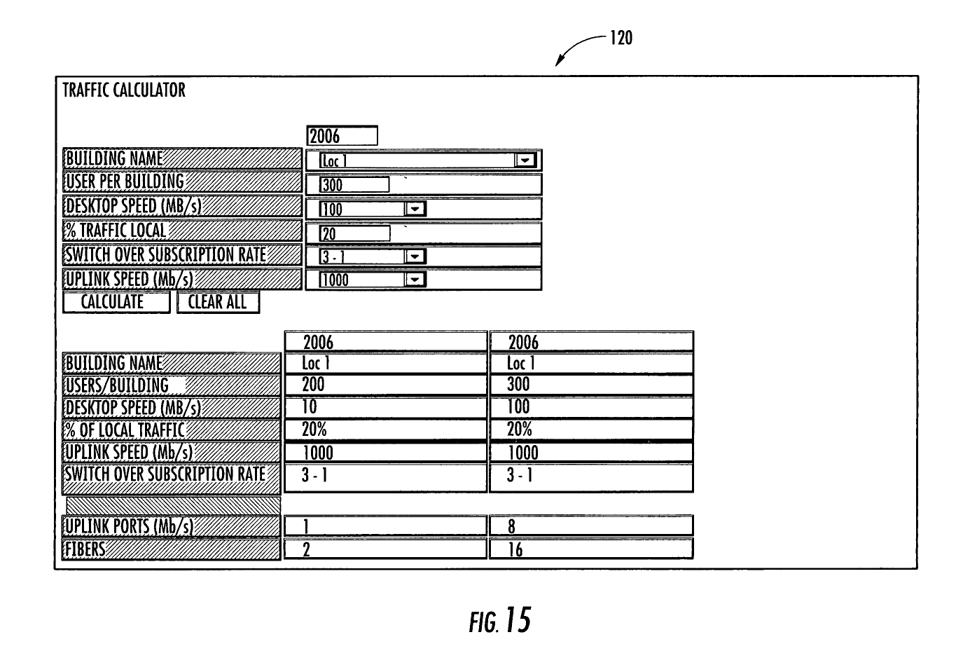

For example, as shown in the graphical report screen 100 of FIG. 11, costs may be plotted versus data rate for various fiber mixes. For example, the screen 100 shows a cross-over point around 2.5 GigE for standard single mode fiber (SMF) versus laser optics at 50-300. Continuing with cost reports, FIG. 12 shows a bar chart 105 of fiber optic and electronics costs for various fiber mixes for a 1 GigE rate. FIG. 13 shows a similar bar chart 110, but for a 10 GigE rate. FIG. 14 shows a bar chart 115 including a 1 GigE trunk and 10 GigE cable and electronics.

Returning again briefly to FIG. 1, another aspect of the invention is directed to a computer implemented online method for fiber optic network design. The method may include prompting and receiving user input data over the Internet 32 relating to the fiber optic network design, and storing a plurality of fiber optic parameters. The method may further include using a calculator/network analyzer module 36 to calculate fiber optic network design data based upon the user input data and the stored fiber optic parameters. The method may also include sending at least one fiber optic network design report to the user over the Internet 32 based upon the calculated fiber optic network design data.

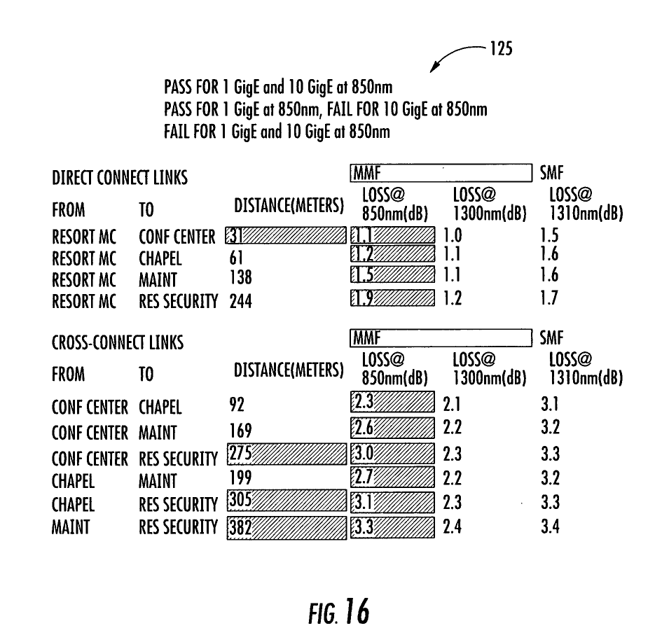

Many other forms of fiber optic network design data can be determined by the calculator/network analyzer module 36 of the system 30 of the present invention. Other online design tools may also be made available to the user. For example, as shown in FIG. 15 a traffic calculator tool input and report screen 120 may be provided that gives various data speeds and percentage of usage figures as will be appreciated by those skilled in the art. In addition, a link loss calculation report 125 may also be generated as shown in the example output screen of FIG. 16.

Many other modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. A computer implemented online system for fiber optic network design comprising:
a user interface module to prompt and receive user input data over a global computer network relating to the fiber optic network design;
a fiber optic parameter database storing a plurality of fiber optic parameters;
a calculator/network analyzer module connected to said user interface module and said fiber optic parameter database to calculate fiber optic network design data based upon the user input data and the stored fiber optic parameters; and
a user report module connected to said calculator/network analyzer module to send at least one fiber optic network design report to the user over the global computer network and based upon the calculated fiber optic network design data.

2. A computer implemented online system according to claim 1 wherein the fiber optic network design data comprises optical fiber type data.

3. A computer implemented online system according to claim 2 wherein the optical fiber type data comprises identification of at least one of a multimode optical fiber having a first core diameter, a multimode optical fiber having a second core diameter larger than the first core diameter, and a single mode optical fiber.

4. A computer implemented online system according to claim 2 wherein the fiber optic network design data further comprises optical fiber cable count data.

5. A computer implemented online system according to claim 1 wherein the fiber optic network design data comprises different optical fiber type data and different optical fiber cable count data for different fiber optic network topologies.

6. A computer implemented online system according to claim 5 wherein the different fiber optic network topologies comprise a point-to-point topology, a point-to-multipoint topology, and a mesh topology.

7. A computer implemented online system according to claim 1 wherein the stored fiber optic parameters comprise different fiber optic parameters for different user applications.

8. A computer implemented online system according to claim 1 wherein the stored fiber optic parameters comprise fiber optic parameters based upon at least one industry standard.

9. A computer implemented online system according to claim 1 wherein the stored fiber optic parameters comprise fiber optic parameters based upon at least one optical fiber cable manufacturer's guidelines.

10. A computer implemented online system according to claim 1 wherein the user input data comprises distances between predetermined locations.

11. A computer implemented online system according to claim 10 wherein the predetermined locations comprise a plurality of buildings in a campus setting.

12. A computer implemented online system according to claim 11 wherein the predetermined locations further comprise different floors in at least one of the buildings.

13. A computer implemented online system according to claim 1 wherein the user input data is based upon fibers needed for different applications.

14. A computer implemented online system according to claim 1 wherein the fiber optic design network data comprises cost data.

15. A computer implemented online system according to claim 14 wherein the at least one report comprises an optical fiber mix breakeven graph.

16. A computer implemented online system according to claim 14 wherein the at least one report comprises an optical fiber cable and electronics cost graph.

17. A computer implemented online system according to claim 1 further comprising a user model database connected to said calculator/network analyzer module for storing user fiber optic network design data for a given set of user input data.

18. A computer implemented online system according to claim 17 further comprising a data mining module connected to said user model database to permit data mining therefrom.

19. A computer implemented online system for fiber optic network design comprising:
a user interface module to prompt and receive user input data over a global computer network relating to the fiber optic network design;
a fiber optic parameter database storing a plurality of fiber optic parameters;
a calculator/network analyzer module connected to said user interface module and said fiber optic parameter database to calculate fiber optic network design data based upon the user input data and the stored fiber optic parameters;
the fiber optic network design data comprising different optical fiber type data and different optical fiber cable count data for different fiber optic network topologies, and cost data; and
a user report module connected to said calculator/network analyzer module to send at least one fiber optic network design report to the user over the global computer network and based upon the calculated fiber optic network design data.

20. A computer implemented online system according to claim 19 wherein the optical fiber type data comprises identification of at least one of a multimode optical fiber having a first core diameter, a multimode optical fiber having a second core diameter larger than the first core diameter, and a single mode optical fiber.

21. A computer implemented online system according to claim 19 wherein the different fiber optic network topologies comprise a point-to-point topology, a point-to-multipoint topology, and a mesh topology.

22. A computer implemented online system according to claim 19 wherein the stored fiber optic parameters comprise fiber optic parameters based upon at least one of an industry standard and an optical fiber cable manufacturer's guidelines.

23. A computer implemented online system according to claim 19 wherein the user input data comprises distances between predetermined locations.

24. A computer implemented online system according to claim 19 further comprising:
a user model database connected to said calculator/network analyzer module for storing user fiber optic network design data for a given set of user input data; and
a data mining module connected to said user model database to permit data mining therefrom.

25. A computer implemented online method for fiber optic network design comprising:
prompting and receiving user input data over a global computer network relating to the fiber optic network design;
storing a plurality of fiber optic parameters;
using a calculator/network analyzer module to calculate fiber optic network design data based upon the user input data and the stored fiber optic parameters; and
sending at least one fiber optic network design report to the user over the global computer network and based upon the calculated fiber optic network design data.

26. A computer implemented online method according to claim 25 wherein the fiber optic network design data comprises optical fiber type data.

27. A computer implemented online method according to claim 26 wherein the fiber optic network design data further comprises optical fiber cable count data.

28. A computer implemented online method according to claim 25 wherein the fiber optic network design data comprises different optical fiber type data and different optical fiber cable count data for different fiber optic network topologies.

29. A computer implemented online method according to claim 25 wherein the stored fiber optic parameters comprise different fiber optic parameters for different user applications.

30. A computer implemented online method according to claim 25 wherein the stored fiber optic parameters comprise fiber optic parameters based upon at least one of an industry standard, and an optical fiber cable manufacturer's guidelines.

31. A computer implemented online method according to claim 25 wherein the user input data comprises distances between predetermined locations.

32. A computer implemented online method according to claim 25 wherein the user input data is based upon fibers needed for different applications.

33. A computer implemented online method according to claim 25 wherein the fiber optic design network data comprises cost data.

34. A computer implemented online method according to claim 25 further comprising storing user fiber optic network design data for a given set of user input data in a user model database connected to the calculator/network analyzer module.

35. A computer implemented online method according to claim 34 further comprising mining data mining from the user model database.
